(19) United States
(12) Patent Application Publication
(10) Pub. No.: US 2005/0249344 A1
(43) Pub. Date: Nov. 10, 2005

(54) Network delivery of personalized caller identification

(75) Inventors: Stephen Mark Mueller, Austin, TX (US); James M. Doherty, Georgetown, TX (US); Rick Anthony Cherye, Austin, TX (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Austin, TX (US)

(21) Appl. No.: 10/840,224

(22) Filed: May 7, 2004

(51) Int. Cl. H04M 3/42

(52) U.S. Cl. 379/207.15

(57) ABSTRACT

A subscriber is provided with personal caller identification information when a telephone call is placed to the subscriber. In particular, a network service platform is supplied with a calling party number. A network caller ID database is queried using the calling party number to retrieve network caller ID information. A central personal address book is queried, using the calling party number, to retrieve personal caller identification information associated with the calling party number. Then the network element forwards the network caller identification information supplemented with the personal caller identification information to the subscriber when connecting the telephone call to the subscriber.

### CROSS-REFERENCE TO RELATED APPLICATIONS

The present application is related to U.S. patent application Ser. No. 09/619,312, filed Jul. 19, 2000, and entitled “System and Method for Providing Remote Access to Telecommunications Services,” which is expressly incorporated by reference herein in its entirety.

### BACKGROUND OF THE INVENTION

1. Field of the Invention

The present invention relates to telecommunications. More specifically, the present invention relates to a personal caller identification service that operates in conjunction with a personal address book in a telecommunications environment enabling a subscriber to receive personal caller identification information.

2. Background Information

A need exists for a subscriber of a telecommunications service to receive personal caller identification information. For example, conventionally a customer of a telecommunications service provider is generally given minimal caller identification information. However, a customer may desire more complete and/or accurate caller identification information than is available from telecommunications service providers.

More specifically, commonly used caller identification (ID) customer premises equipment (CPE) displays only the information supplied to it by the network. In an increasing number of cases, the network now supplies a calling number, but not a calling name (e.g., for calls from wireless phones or call originating carriers from which a network does not receive calling name information). The limited caller ID information has made caller ID increasingly less useful, especially for households that receive many calls from wireless callers or households with many colleagues, friends, and relatives served by carriers that do not deliver calling names. To address this problem, CPE has been designed to correlate calling numbers with a personal list of names that are entered into and stored in the CPE itself.

While enhancing CPE, as described above, is a solution to provide personal caller ID information, it is less than ideal. Using such CPE requires additional interaction by the user to load names and telephone numbers into each CPE, each likely with different interfaces, and each CPE would then have to be separately updated.

Thus, a telecommunications system and method are needed for providing personal caller identification information from a central personal address book that stores contact information. In addition, a telecommunications system and method are needed for updating the personal address book to provide personal caller identification information for calling parties.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawings, and in which:

FIG. 1 shows an exemplary network architecture for the personal caller identification service used in conjunction with an address book system, according to an aspect of the present invention;

FIG. 2 is a call flow diagram showing an exemplary call flow of the personal caller identification information service, according to an aspect of the present invention;

FIG. 3 is a call flow diagram showing an exemplary call flow of the personal caller identification information service, according to another aspect of the present invention;

FIG. 4 is a logic flow chart showing an exemplary method of the personal caller identification information service, according to an aspect of the present invention; and

FIG. 5 is a flow diagram showing an exemplary method of modifying a personal address book for a personal caller identification information service, according to another aspect of the present invention.

### DETAILED DESCRIPTION OF THE INVENTION

In view of the foregoing, the present invention, through one or more of its various aspects, embodiments and/or specific features or sub-components, is thus intended to bring out one or more of the advantages as specifically noted below.

The present invention is directed to a telecommunications service and method that deliver, for a subscriber of a telecommunications service, personal caller identification information from a personal address book. The address book includes, for example, contact information for the subscriber. Thus, the standard network caller ID information is supplemented with personal caller ID information.

The present invention is a network solution. The network solution is preferable to a CPE-based solution in that it provides numerous advantageous to a telecommunications service provider. For example, a network solution will support a continuous monthly revenue stream and will promote customer loyalty. In this regard, once a subscriber has entered personal data into the address book, they are less likely to cancel the service. Additional advantages are that the personal caller ID service can build on an existing personal call manager (PCM) service and personal address capabilities. Such a PCM system is described in U.S. patent application Ser. No. 09/619,312 entitled “System and Method for Providing Remote Access to Telecommunications Services,” filed Jul. 19, 2000, which is expressly incorporated by reference herein in its entirety. The personal caller ID service can share a common interface with other PCM services.

The network-based solution of the present invention further allows subscribers to the service to use all of their existing caller ID equipment, regardless of whether it exists as separate pieces of equipment or is incorporated into handsets and further regardless of whether the equipment is wireless or wireline.

According to another aspect of the present invention, users load names that match telephone numbers into their personal address book via a user interface, such as a web-based interface, rather than a plethora of interfaces that vary drastically from one piece of equipment to another. Further, the web interface is far richer and easier to use than the interface and menus typically found on such CPE. Furthermore, being network based, the personal caller ID service uses the same mechanisms as regular caller ID service to deliver personalized caller ID information and thus, automatically presents the same set of information to all of a user's caller ID equipment.

One aspect of the present invention includes a method of providing a subscriber with personal caller identification information. The method includes supplying a network service platform with a calling party number in response to a telephone call from the calling party number. The method further includes querying a central personal address book, using the calling party number, to retrieve personal caller identification information associated with the calling party number. The method also including forwarding the network caller identification information supplemented with the personal caller identification information when connecting the telephone call to the subscriber.

The method can also include determining when a telephone call is being placed, in a telecommunications network, to the subscriber. The method can also include querying a network caller identification database, using the calling party number, to retrieve the network caller identification information. The telecommunications network can be a voice over internet protocol (VOIP) network, a wireless network, or a public switched telephone network (PSTN). The method can further include logging each telephone call to the subscriber as an entry comprising at least one of the personal caller identification information, date, time, and calling party telephone number. The method can further include retrieving the logged telephone call information, selecting one entry of the logged telephone call information, adding the entry to the personal address book, and modifying the entry to personalize the caller identification information. Finally, the method can further include allowing the retrieving, selecting, adding, and modifying of the entry to occur during a web browsing session.

Another aspect of the invention is a system for providing a subscriber with personal caller identification information. The system including a network service platform that receives a calling party number in response to a telephone call from the calling party number. The system further including a central personal address book that is queried, using the calling party number, to retrieve personal caller identification information associated with the calling party number. The network caller identification information is supplemented with the personal caller identification information and forwarded to the subscriber when connecting the telephone call to the subscriber.

The system can further include a network element that determines when a telephone call is being placed, in a telecommunications network, to the subscriber. The system network service platform can be a SCP, SIP feature server, or Parlay gateway. The system can also include a network caller identification database that is queried, using the calling party number, to retrieve the network caller identification information. The telecommunications network can be a voice over internet protocol (VoIP) network, a wireless network, or a public switched telephone network (PSTN). The system can also include a database that logs each telephone call to the subscriber as an entry with one or more of the personal caller identification information, date, time, or calling party telephone number.

Yet another aspect of the invention is a computer readable medium for storing a computer program that provides a subscriber with personal caller identification information. The computer readable medium includes code that supplies a network service platform with a calling party number in response to a telephone call from the calling party number. The computer readable medium also includes code that queries a central personal address book, using the calling party number, to retrieve caller identification information associated with the calling party number. The computer readable medium further includes code that forwards the network caller identification information supplemented with the personal caller identification information when connecting the telephone call to the subscriber.

The computer readable medium can also include code that queries a network caller identification database, using the calling party number, to retrieve the network caller identification information. The computer readable medium can also include code that logs each telephone call to the subscriber as an entry with one or more of the personal caller identification information, date, time, or calling party telephone number. The computer readable medium can further include code that retrieves the logged telephone call information, code that selects one entry of the logged telephone call information, code that adds the entry to the personal address book, and code that modifies the entry to include personal caller identification information. The computer readable medium can also include code for retrieving, selecting, adding, and modifying the entry to occur during a web browsing session.

Another aspect of the invention is a telecommunications system that provides a subscriber with personal caller identification information. The system includes a network element that determines when a telephone call is being placed, in a telecommunications network, to the subscriber. The system further includes a network service platform that receives the calling party number from the network element in response to a telephone call from the calling party number. The system further includes a network caller identification database that is queried, using a calling party number, to retrieve network caller identification information. The system further includes a central personal address book that is queried, using the calling party number, to retrieve personal caller identification information associated with the calling party number, where the network element forwards the network caller identification information supplemented with the personal caller identification information to the subscriber when connecting the telephone call to the subscriber. The telecommunications network can be a voice over internet protocol (VOIP) network, a wireless network, or a public switched telephone network (PSTN).

The personal caller identification system operates separately or as a component or enhancement of a Personal Call Manager (PCM) system. Such a PCM system is described in U.S. patent application Ser. No. 09/619,312 entitled “System and Method for Providing Remote Access to Telecommunications Services,” filed Jul. 19, 2000, which is expressly incorporated by reference herein in its entirety. The PCM system can provide an interface to telecommunications services, such as personal address books, incoming call manager, outgoing call control, call logging, and the like.

The present invention can extend and integrate the call logging service and personal address book of the PCM service with a network caller ID to support network delivery of personal caller ID information to a user's caller ID CPE. Thus, the present invention allows the user to supplement caller ID information from a network calling name database with the user's own customized information to be displayed on the user's CPE. However, it should be apparent that the present invention need not be integrated with the PCM service.

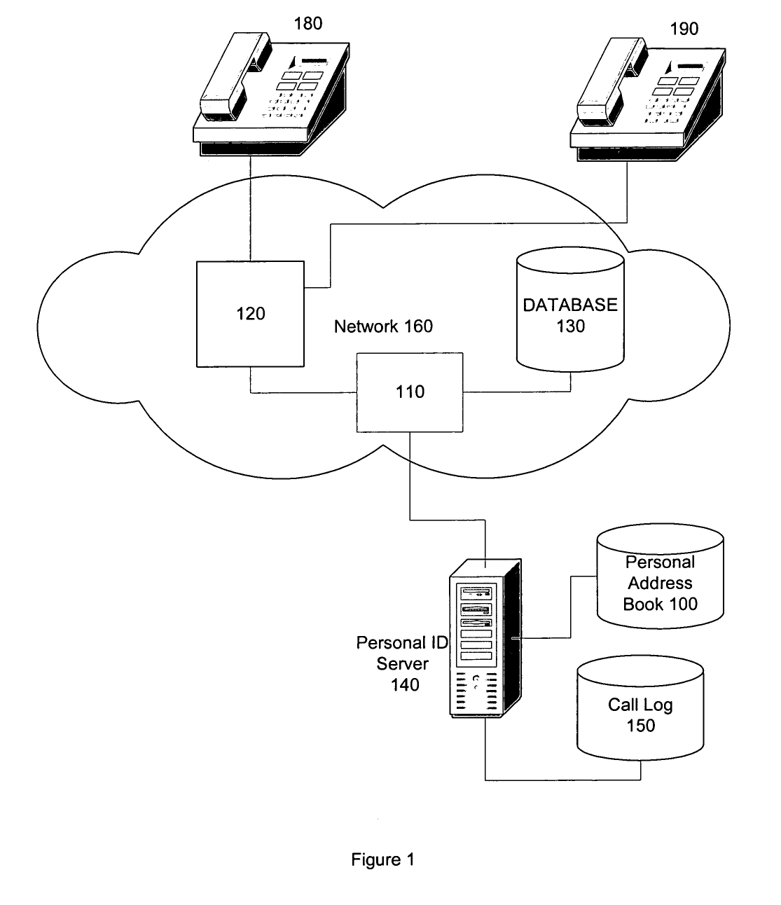

FIG. 1 shows an exemplary service architecture for the personal caller identification information service and the personal address book. The exemplary service architecture includes a personal address book 100, service platform 110, network element 120, a database 130 such as line information data base/calling name database (LIDB/CNAM), a personal caller ID server 140, a call log 150, and a network 160. Also shown in FIG. 1 is the CPE of subscriber 180 and the CPE of a calling party 190.

The call log 150, personal caller ID server 140, and personal address book 100 include hardware components and software components. In an embodiment, the call log 150, personal caller ID server 140, and personal address book 100 include one or more memories, servers, processors, and/or routers, none of which are shown in FIG. 1. The server(s) may be a web server(s) and/or an application server(s) that process messages of a specific telecommunications format or a specific application. Accordingly, multiple servers may be provided to ensure telecommunications capability for multiple formats and modes of the personal caller identification information service. Furthermore, it should be apparent that all or part of the personal address book 100, personal caller ID server 140, and call log 150 can be embodied in the network service platform 110.

The embodiment of FIG. 1 shows the personal address book 100, personal caller ID server 140, and call log 150 as separate components, but of course, these components can be combined, separate and/or distributed. Additionally, the personal caller ID service can be integrated with the PCM service. In such as case, the personal ID server 140 can be implemented to provide all PCM services. Furthermore, it should be apparent that the personal address book 100, personal caller ID server 140, and call log 150 can be combined with the service platform 110. The service platform 110 is part of a telecommunications network 160, that is connected to the CPE of subscriber 180. In particular, in the embodiment of FIG. 1, the subscriber 180 accesses the telecommunications network 160 using the CPE.

In the present invention, a calling party 190 will place a call to the subscriber 180. Although FIG. 1 shows that the calling party 190 and subscriber 180 directly connected to the same network element 120, the calling party 190 and subscriber 180 can, of course, be connected to different network elements that are capable of communicating with each other.

The network 160 is merely representative of a telecommunications network connected to the personal ID server 140 and CPE. The network 160 is, for example, the internet using voice over internet protocol (VoIP), a wireline network such as the public switched telephone network (PSTN) incorporating advanced intelligent network (AIN) technology, a wireless network, or any other type of telecommunications network.

The network 160 includes several network elements. One such network element 120 that is responsible for processing a telephone call is shown as part of the network 160 of FIG. 1. The network element 120 can be provisioned in a wireline network as a service switching point (SSP). The SSP can be a class 5 switch such as the 5ESS available from Lucent Technologies, Inc. of Murray Hill, N.J., or the DMS 100 available from Northern Telecom Ltd. (Nortel Networks) of Brampton, Ontario, Canada.

In a wireless network, the network element 120 can be a mobile switching center (MSC). Such a MSC can be the CDMA2000 CMX(3G) Mobile Switching Center (MSC) from Ericsson of Plano, Tex.

In a VoIP system, the network element 120 can be deployed as a softswitch. As a specific example, the softswitch can be, for example, a serving GPRS support node (SGSN) or gateway GPRS support node (GGSN). Such a softswitch can be the SURPASS hiQ 8000 Softswitch from Siemens AG of Munich, Germany.

The network element 120 is connected within the network 160 to the service platform 110. In a wireline network, the service platform 110 can be provisioned as a service control point (SCP) using advanced intelligent network (AIN) or intelligent network application part (INAP) signaling. The SCP can be, the AINGR service control point from Telcordia Technologies of Piscataway, N.J.

In a wireless network, the service platform 110 can be provisioned as a wireless SCP using wireless intelligent network (IN) or global system for mobile (GSM) customized application of mobile enhanced logic (CAMEL) signaling.

In a VoIP network, the service platform 110 can be provisioned as a SIP feature server, or a Parlay gateway that can operate with various protocols such as AIN, INAP, WIN, CAMEL, SIP, as well as other protocols. Such a feature server can be the SIP Proxy Server from Cisco Systems of San Jose, Calif.; or the Applications Feature Server from Sylantro of Campbell, Calif. The Parlay gateway integrates network capabilities through a secure interface. Parlay allows third party applications to be hosted within a telecommunications operator's own network and allows applications running on external application servers to offer their service to the operator's subscribers via a secure gateway. In particular, the Parlay gateway allows the transfer of the call signaling for use with the third party to provide the personal caller ID information service. Such a Parlay gateway can be MiLife Intelligent Services Gateway from Lucent Technologies Inc. of Murray Hill, N.J.; or the Causeway Parlay from AePONA Ltd. of Belfast, Northern Ireland.

A subscriber telecommunications device or CPE can be a telephone. Of course, the CPE can be a personal digital assistant (PDA), Internet Protocol (IP) phone, or any other device capable of placing and receiving telephone calls.

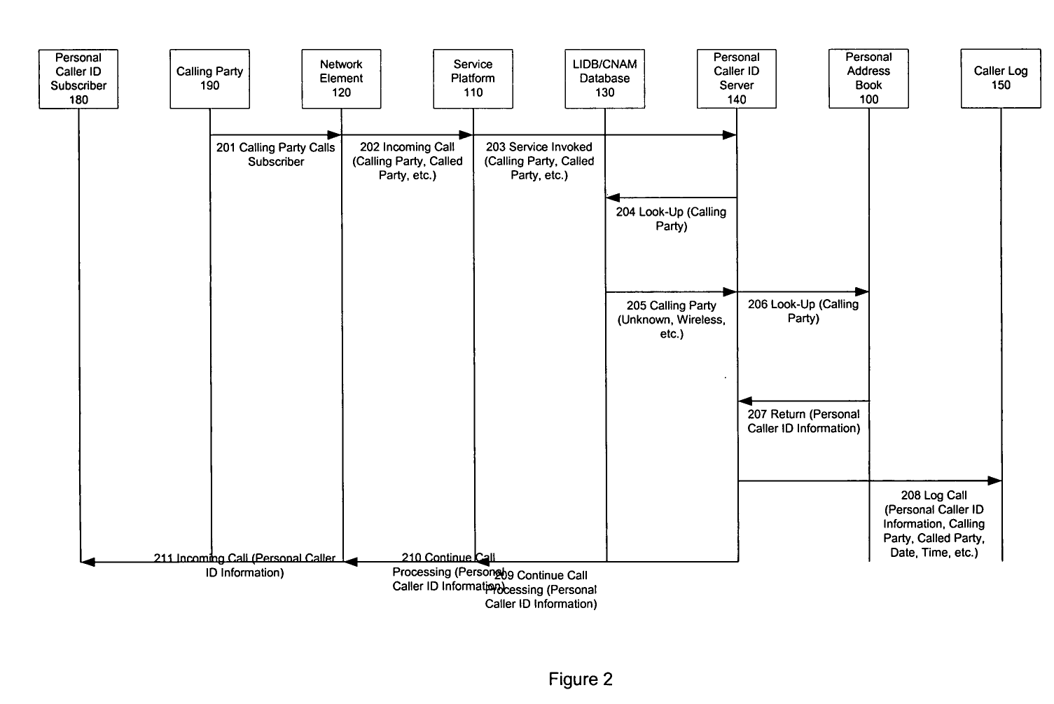

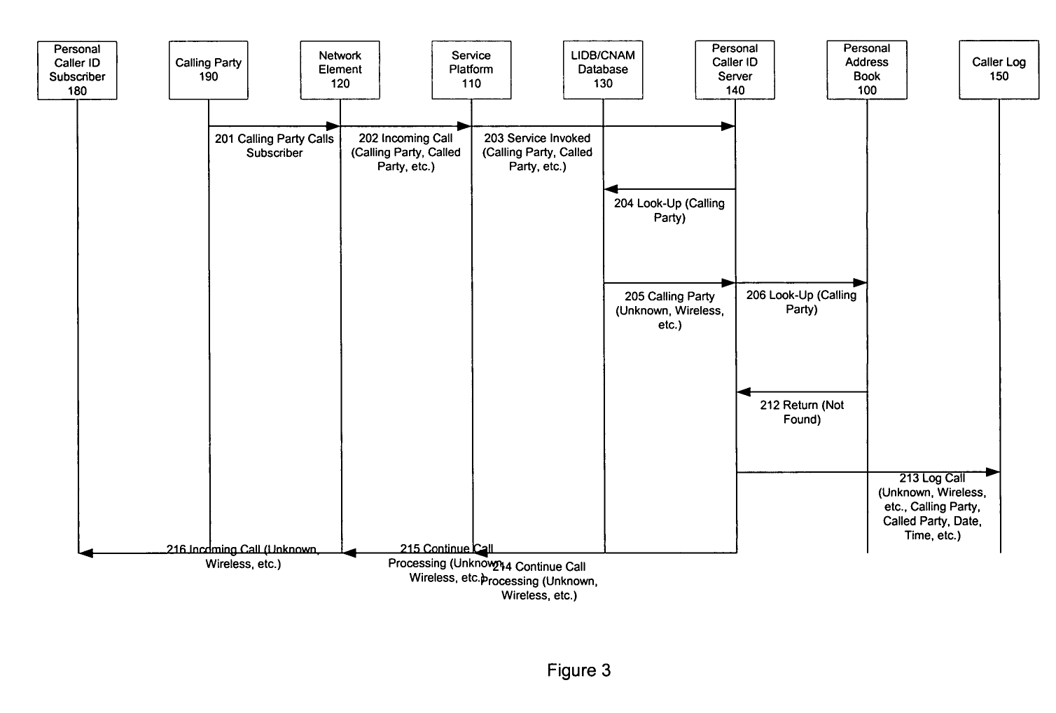

FIGS. 2 and 3 show exemplary call flows for several processes of the personal caller identification information service and the personal address book 100 when the subscriber's personal address book 100 populates both an optional call log entry and the display on the subscriber's caller ID equipment.

As shown in FIG. 2, a calling party 190 places a telephone call to a subscriber 180 in step 201. The telephone call is placed to a subscriber 180 from or to any type of telecommunications network, including a wireline, wireless, and VoIP network. Placing the telephone call initiates call signaling that includes call set-up messages. The call set-up messages vary depending on the network on which the caller is dialing. In a wireless and wireline network, a signaling system 7 (SS7) ISDN user part (ISUP) initial address message (IAM) is used. In a VoIP system, a session initiation protocol (SIP) INVITE message is used. However, it should be noted that the call set-up messages can be any other functionally equivalent messages in another analogous protocol.

Next, the network element 120 responsible for handling the call determines that the call is destined for a subscriber 180 and signals the service platform 110 in step 202. The determination by the network element 120 that the call is to the subscriber 180 is based on the call set-up signaling. For example, the call set-up signaling is recognized by the network element 120 indicating a call to the subscriber 180. The network element 120 will then allow further processing of the call. In a wireline network, a trigger, such as a terminating attempt trigger (TAT), is set in a SSP. For example, the SSP sends an AIN or INAP message to the SCP or Parlay gateway that requests processing. In a wireless network, the MSC sends a CAMEL message to the SCP or Parlay gateway requesting processing of the trigger. In a VoIP network, the softswitch forwards a SIP INVITE message to a SIP application server or to a Parlay gateway for processing. The call set-up signaling is forwarded to the service platform 110. In particular, the service platform 110 is supplied with information such as the calling party telephone number, called party telephone number, and other information that is not germane to the present invention, as shown in step 202.

Next, the service platform 110 (e.g., SCP, SIP application server, or Parlay gateway) determines that the called party has the personal caller ID service. The service platform 110 then invokes the personal caller ID service on the personal caller ID Server 140 as shown in step 203. Further in step 203, the personal caller ID server 140 is supplied with information such as the calling party telephone number and the called party telephone number. The actual signaling of notifying the personal caller ID server 140 may vary depending on the network platform 110 being used. However, one implementation uses the INVOKE APPLICATION message of the generic data interface (GDI) protocol to invoke the personal caller ID service.

In a SIP application server embodiment, the SIP application server also acts as the personal caller ID server 140 and thus does not send a message. If, the Parlay gateway is employed, it uses CORBA to invoke a report notification method on the personal caller ID server 140.

In the examples of FIGS. 2 and 3, the personal caller ID server 140 determines that the called party subscribes to the personal caller ID service and a call logging service. Of course, it should be noted that the call logging service does not have to be included with the personal caller ID aspect of the present invention. The personal caller ID server 140 first queries the network caller ID databases 130, such as line information data base/calling name database (LIDB/CNAM) 130, for a match to the calling party number as shown in step 204. The database 130 either finds an entry including the calling party name or it finds only that the calling party is a wireless caller, a caller out of the area known to the database 130, or otherwise unknown. In the example of FIG. 2, unknown caller or wireless caller from the LIDB/CNAM, and other information that is not germane to the present invention, is forwarded to the personal caller ID server 140 in step 205.

The personal caller ID server 140, queries the personal caller ID subscriber's own personal address book 100 to see if there is a match to the calling number in step 206. When there is a match, the personal address book 100 will return the personal caller ID information to the personal caller ID server 140 in step 207.

Because the personal caller ID subscriber also subscribes to the call logging service in the FIG. 2 example, the personal caller ID server 140 logs the telephone call with personal caller ID information along with calling party telephone number, called party, date of call, and time of call information, for example only, in step 208. Next, the personal caller ID server 140, having completed the logging and look-up functions, forwards the personal caller ID information and the telephone number of the calling party to the service platform 110 in step 209.

In one implementation, the SCP is sent a reply to the GDI INVOKE APPLICATION message that was sent previously. If a SIP application server is provisioned, where the SIP server is acting as the personal caller ID server 140, there is no need to exchange messages. In an implementation using the Parlay gateway, the personal caller ID server 140 uses CORBA signaling to return results of the report notification to the Parlay gateway.

The network element 120 will continue call processing with the available network caller ID information supplemented with the personal caller ID information in step 210. In the wireline network, the SCP sends a response to the trigger message that includes the network caller ID information supplemented with the personal caller ID information. The wireless network is similar to the wireline network, except that the response is a CAMEL message. In a VoIP network, an application server SIP INVITE message is sent with the network caller ID information supplemented with the personal caller ID information.

The network connects the call to the personal caller ID subscriber 180, using the normal processes of delivering caller ID information to provide network caller ID information supplemented with the personal caller ID information. The personal caller ID information includes calling name information from the personal address book 100 as shown in step 211. The subscriber 180 then receives the call with the network caller ID information supplemented with the personal caller ID information that is displayed on the personal caller ID subscriber's CPE.

FIG. 3 shows an exemplary call flow diagram of the personal caller identification information system when a calling party is not listed in the personal caller ID subscriber personal address book 100.

As shown in FIG. 3, a calling party 190 will place a telephone call to the personal caller ID subscriber 180 in step 201 and the call flow steps and logic will be the same as previously described for step 201 through step 206 of FIG. 2.

In this case, the personal address book 100 does not list a calling party associated with the telephone number. The address book 100 does not return any calling party information as shown in step 212.

In step 213, the personal caller ID server 140 logs the call with the called party information from the network or LIDB/CNAM 130 retrieved in step 205, along with calling party telephone number, called party, date of call, and time of call information, for example only. Next, the personal caller ID server 140, having completed processing, in step 214 signals the service platform 110 to continue call processing and subsequently the personal caller ID server 140 sends the network caller ID information to the network element 120 in step 215. Finally, the network then connects the call to the personal caller ID subscriber 180, using the normal processes of delivering caller ID to provide the network calling ID information in step 216.

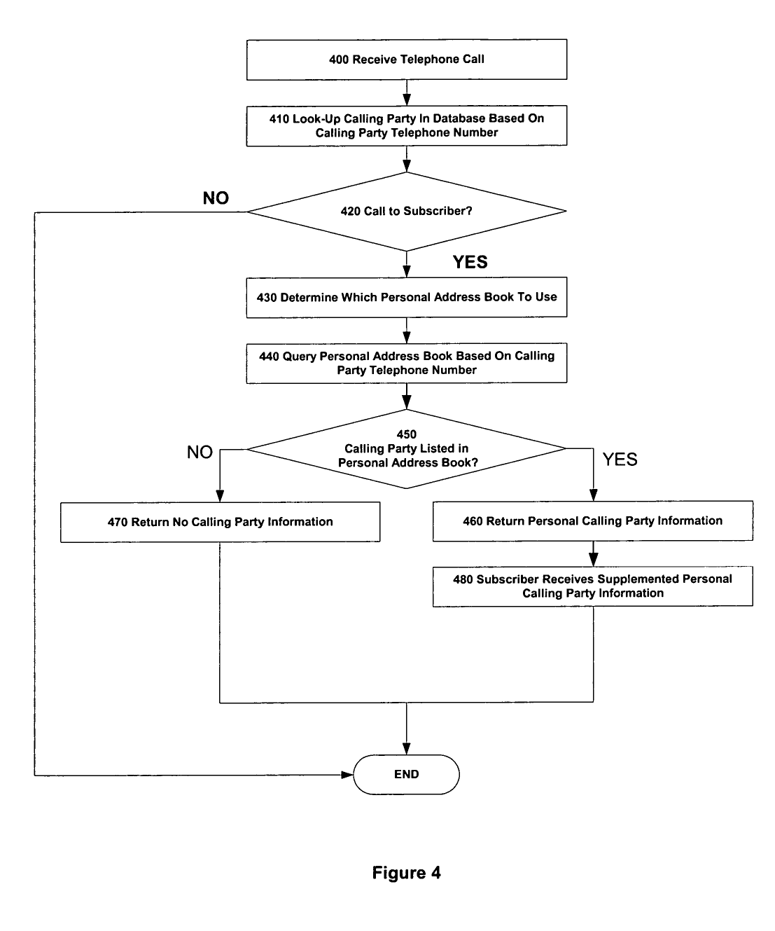

FIG. 4 is a logic flow chart showing an exemplary method of the personal caller identification information service, according to an aspect of the present invention. In step 400, the network element 120 receives call signaling to place a telephone call. Next, the database 130, such as the LIDB/CNAM database 130, will be queried and will return the network caller ID information in step 410. Next, it is determined whether the telephone call is being placed to a subscriber as shown in step 420. If the call is not being placed to a subscriber, then the result of step 420 is a “NO,” the process will end, and the call will be placed to the called party with the network caller ID information. If the call is being placed to the subscriber 180, then the result of step 420 will be a “YES” and the personal caller ID service will be invoked.

Next, because the personal ID server 140 has a multiple subscribers, the personal ID server 140 will determine which of the personal address books 100 to use, based on the called party information as shown in step 430. The personal ID server 140 will then query the subscriber's personal address book 100 based on the calling party number and the called party telephone number that it received from the network element 120 as shown in step 440.

At step 450, after the address book 100 is queried, if there is no calling party listed based on the query, step 450 will result in a “NO.” Thereafter, the logic will advance to step 470. In this case, the address book 100 has returned no calling party information. The process will end and the subscriber call will be placed with only the network caller ID information that was obtained in step 420.

If at step 450, it is determined that calling party information is listed in the personal address book 100, then a “YES” answer will advance the logic to step 460. At step 460, the personal address book 100 will return personal caller ID information to the personal ID server 140. Next, at step 480, the subscriber 180 will receive the network caller ID information supplemented with the personal caller ID information when the call is placed to the subscriber 180.

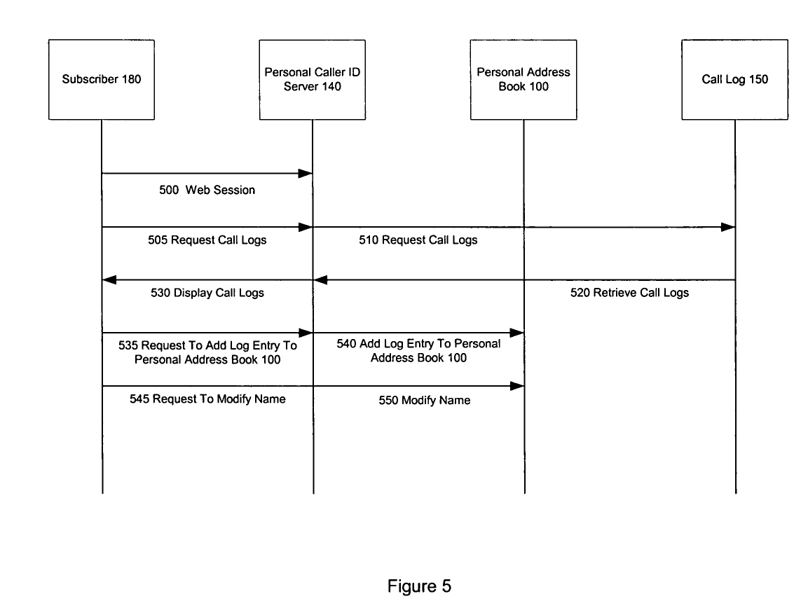

Next, the manner in which a subscriber 180 modifies the personal address book 100 will be discussed in conjunction with FIG. 5.

FIG. 5 shows an exemplary flow chart for when a subscriber modifies the personal address book 100 in an embodiment where the subscriber also subscribes to the call logging service of the PCM service. In this embodiment, the personal caller ID subscriber can use call logs to populate the personal address book 100. Moreover, the subscriber can change calling names (e.g. “Unknown,” “Wireless Caller,” and the like) to values the subscriber 180 will find more useful in the future.

In this regard, the personal caller ID Subscriber 180 establishes a web browsing session in step 500 with the personal caller ID Server 140 in order to access various PCM services. The various PCM services can include one or more of a personal address books, incoming call manager, outgoing call control, call logging, and the like. The PCM service can provide a single interface to each and all of these services. One such service can be to retrieve the call logs that have been created during the call logging process when the subscriber subscribes to the call logging service of the PCM service. The personal caller ID subscriber 180 then requests the call logs that contain the calling party number and any other associated information in step 505. In step 510, the personal caller ID server 140 requests call logs from the call log 150.

The personal caller ID server 140 receives the call logs in step 520 and displays them to the personal caller ID subscriber 180 on the subscriber's web browser in step 530 of their personal computer. Each of the telephone calls to the personal caller ID subscriber are logged as a log entry, as previously noted, if the subscriber 180 also subscribes to the call logging feature of the PCM service.

The personal caller ID subscriber 180 then selects one of the log entries and then instructs the personal caller ID server 140 to add a telephone number for the selected entry to their personal address book 100 as shown in step 535. Subsequently, the personal caller ID server 140 adds the telephone number to the personal address book 100 in step 540.

If the personal caller ID Subscriber 180 is not satisfied with a calling name in the call log (e.g., prefers “Mom and Dad” over “Smith, John,” “Unknown,” “Wireless Caller,” and the like), the subscriber 180 can then request to modify the personal address book entry to a preferred name as shown in step 545. The preferred name will be saved in the personal address book 100 in step 550 and in response to a call will subsequently be used to populate the call log 150 and the caller ID equipment of each of the subscriber's CPE.

It should be apparent that although the personal address book 100 is described as being modified through a web interface, any known interface to modify address book 100 is within the scope of the present invention. It should be further noted, that although FIG. 5 and the corresponding description show that the personal caller ID server 140 operates as both the personal caller ID service and as a web interface, separate servers can provide the same capabilities.

Thus, the present invention provides a subscriber 180 with more useful personal caller ID information that is delivered directly to their caller ID equipment. The personal caller ID information is based on the subscriber's personal address book 100. The present invention further provides the subscriber 180 with the ability to modify the personal address book 100 so that the personal caller ID information delivered by the network 160 can be changed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards (e.g., AIN, SS7, CORBA, SIP, CAMEL) represent examples of the state of the art. Such standards are periodically superseded by faster or more efficient equivalents having essentially the same functions. Accordingly, replacement standards and protocols having the same functions are considered equivalents.

1. A method of providing a subscriber with personal caller identification information, the method comprising:
supplying a network service platform with a calling party number in response to a telephone call from the calling party number;
querying a central personal address book, using the calling party number, to retrieve personal caller identification information associated with the calling party number; and
forwarding the network caller identification information supplemented with the personal caller identification information when connecting the telephone call to the subscriber.

2. The method according to claim 1, further comprising:
determining when a telephone call is being placed, in a telecommunications network, to the subscriber.

3. The method according to claim 1, further comprising:
querying a network caller identification database, using the calling party number, to retrieve the network caller identification information.

4. The method according to claim 1, wherein the telecommunications network comprises one of a voice over internet protocol (VoIP) network, a wireless network, and a public switched telephone network (PSTN).

5. The method according to claim 1, further comprising:
logging each telephone call to the subscriber as an entry comprising at least one of the personal caller identification information, date, time, and calling party telephone number.

6. The method according to claim 5, further comprising:
retrieving the logged telephone call information;
selecting one entry of the logged telephone call information;
adding the entry to the personal address book; and
modifying the entry to personalize the caller identification information.

7. The method according to claim 6, wherein retrieving, selecting, adding, and modifying the entry occur during a web browsing session.

8. A system for providing a subscriber with personal caller identification information, the system comprising:
a network service platform that receives a calling party number in response to a telephone call from the calling party number; and
a central personal address book that is queried, using the calling party number, to retrieve personal caller identification information associated with the calling party number,
wherein the network caller identification information is supplemented with the personal caller identification information and forwarded to the subscriber when connecting the telephone call to the subscriber.

9. The system according to claim 8, further comprising:
a network element that determines when a telephone call is being placed, in a telecommunications network, to the subscriber.

10. The system according to claim 8, wherein the network service platform comprises one of a SCP, SIP feature server, and Parlay gateway.

11. The system according to claim 8, further comprising:
a network caller identification database that is queried, using the calling party number, to retrieve the network caller identification information.

12. The system according to claim 8, wherein the telecommunications network comprises one of a voice over internet protocol (VoIP) network, a wireless network, and a public switched telephone network (PSTN).

13. The system according to claim 8, further comprising:
a database that logs each telephone call to the subscriber as an entry comprising at least one of the personal caller identification information, date, time, and calling party telephone number.

14. A computer readable medium for storing a computer program that provides a subscriber with personal caller identification information, the computer readable medium comprising:
code that supplies a network service platform with a calling party number in response to a telephone call from the calling party number;
code that queries a central personal address book, using the calling party number, to retrieve caller identification information associated with the calling party number; and
code that forwards the network caller identification information supplemented with the personal caller identification information when connecting the telephone call to the subscriber.

15. The computer readable medium according to claim 14, further comprising:
code that queries a network caller identification database, using the calling party number, to retrieve the network caller identification information.

16. The computer readable medium according to claim 14, further comprising:
code that logs each telephone call to the subscriber as an entry comprising at least one of the personal caller identification information, date, time, and calling party telephone number.

17. The computer readable medium according to claim 16, further comprising:
code that retrieves the logged telephone call information;
code that selects one entry of the logged telephone call information;
code that adds the entry to the personal address book; and
code that modifies the entry to include personal caller identification information.

18. The computer readable medium according to claim 17, wherein retrieving, selecting, adding, and modifying the entry occur during a web browsing session.

19. A telecommunications system that provides a subscriber with personal caller identification information, the system comprising:
a network element that determines when a telephone call is being placed, in a telecommunications network, to the subscriber;
a network service platform that receives the calling party number from the network element in response to a telephone call from the calling party number;
a network caller identification database that is queried, using a calling party number, to retrieve network caller identification information; and
a central personal address book that is queried, using the calling party number, to retrieve personal caller identification information associated with the calling party number,
wherein the network element forwards the network caller identification information supplemented with the personal caller identification information to the subscriber when connecting the telephone call to the subscriber.

20. The system according to claim 19, wherein the telecommunications network comprises one of a voice over internet protocol (VoIP) network, a wireless network, and a public switched telephone network (PSTN).
